(19) United States
(12) Patent Application Publication
(10) Pub. No.: US 2019/0108465 A1
(43) Pub. Date: Apr. 11, 2019

(54) SYSTEMS AND METHODS FOR PREDICTING PROBABILITIES OF PROBLEMS AT SERVICE PROVIDERS, BASED ON CHANGES IMPLEMENTED AT THE SERVICE PROVIDERS

(71) Applicant: MASTERCARD INTERNATIONAL INCORPORATED, Purchase, NY (US)

(72) Inventors: Xianzhe Zhou, Town and Country, MO (US); Xiaoying Zhang, O'Fallon, MO (US); Meghana Santhapur, O'Fallon, MO (US)

(21) Appl. No.: 16/154,223

(22) Filed: Oct. 8, 2018

Related U.S. Application Data
(60) Provisional application No. 62/569,972, filed on Oct. 9, 2017.

(51) Int. Cl. G06Q 10/06; G06F 17/27; G06F 17/16

(52) U.S. Cl. CPC G06Q 10/0635; G06F 17/16; G06F 17/2785; G06Q 10/06375

(57) ABSTRACT

Systems and methods are provided for predicting a probability of a problem in a service at a service provider based on implementation of a change to the service. One exemplary method includes a risk engine accessing change records for historical changes in services associated with the service provider where each record includes a text description of the implemented change and a problem/no problem result for the change. For each record, the risk engine normalizes the text description of the implemented change and generates a word-count matrix based on the normalized text description. The risk engine then performs a regression analysis of the generated word-count matrices for the records and the corresponding problem/no problem results, thereby providing a regression model, and generates a predictive algorithm based on a score provided from the regression model and at least one change factor associated with the change records.

### CROSS-REFERENCE TO RELATED APPLICATION

This application claims the benefit of, and priority to, U.S. Provisional Application No. 62/569,972 filed on Oct. 9, 2017. The entire disclosure of the above-referenced application is incorporated herein by reference.

### FIELD

The present disclosure generally relates to systems and methods for use in providing probabilities of problems at service providers based on implementation of changes at the service providers.

### BACKGROUND

This section provides background information related to the present disclosure which is not necessarily prior art.

Service providers are known to provide services to customers, where the customers may be individuals, business, companies, etc. The services often rely on assets of the service providers, in order to operate as intended. For example, a virtual wallet application service may rely on server assets, application programming interface (API) assets, and application assets of a service provider, in order to enable a customer's smartphone to provide virtual wallet functionality. More generally, assets may include, for example, computing devices (e.g., desktops, servers, data centers, etc.), platform service assets (e.g., service busses, message brokers, etc.) and software assets in the form of services, APIs, etc. From time to time, the assets may need to be modified, serviced, replaced, or improved, all of which are understood to be (or involve) changes to the assets. When making such changes to the assets, then, the service providers associated with the assets are known to impose strict procedures to ensure and/or inhibit problems arising from the changes. But even with such precautions, such problems inevitably occur.

### DRAWINGS

The drawings described herein are for illustrative purposes only of selected embodiments and not all possible implementations, and are not intended to limit the scope of the present disclosure.

FIG. 1 illustrates an exemplary payment system including one or more aspects of the present disclosure, for providing a probability of a problem at a service provider associated with the payment network based on implementation of a change at an asset associated with the service provider;

FIG. 2 is a block diagram of an exemplary computing device that may be used in the payment system of FIG. 1; and

FIG. 3 is an exemplary method for providing a probability of a problem at a service provider based on implementation of a change at an asset associated with the service provider, which can be implemented via the payment system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When changes are to be implemented at a service provider, the changes may be minor in scope or they may be substantial. Regardless of the scope of the changes, problems may arise from the changes (e.g., based on underlying management of the changes, operational failures, release issues, etc.), which may affect one or, potentially, multiple services offered by the service provider. In connection therewith, the inventors hereof have recognized that a relationship may exist between the changes to be implemented at the service provider and corresponding incidents arising with/at the service provider following such changes. And, the inventors have developed a machine learning approach, making use of text-mining, to evaluate such relationship.

With that in mind, the systems and methods herein uniquely provide risk scoring for evaluating such changes to the service provider (via one or more machine learning models), whereby a risk associated with the change is quantified. In particular, historical changes made to the service provider are evaluated, where the changes resulted in one or more problems. The historical changes then provide a training data set that includes a text description for each change and a problem/no problem result of the change. A risk engine accesses the training data set and, specifically, the text descriptions thereof, and normalizes the text descriptions (e.g., cleans the descriptions, removes stop words, and/or stems the descriptions, etc.). Thereafter, the risk engine performs a term-based analysis on the normalized text descriptions (broadly, a classifier analysis), such as, for example, determining a term frequency-inverse document frequency (tf-idf) matrix for each of the normalized text descriptions, etc. The risk engine next performs a logistic regression, or other suitable analysis, on the tf-idf matrix and the problem/no problem result, which results in a regression model with the appropriate coefficients and/or weighting. The risk engine then augments the regression model with one or more change factors, etc., through a further analysis (e.g., through a random forest model or other suitable machine learning model, etc.). And, the result is a predictive algorithm. Then, later, for subsequent changes, the risk engine analyzes text descriptions for the changes, as before (e.g., again using normalization, generating a tf-idf matrix, etc.), and then applies the predictive algorithm to yield probabilities that problems will or will not occur for the subsequent changes. In this manner, the service provider is informed of a likelihood of problems occurring for various different subsequent changes, whereby the service provider may preemptively impose additional processes and/or oversights on implementation of the changes.

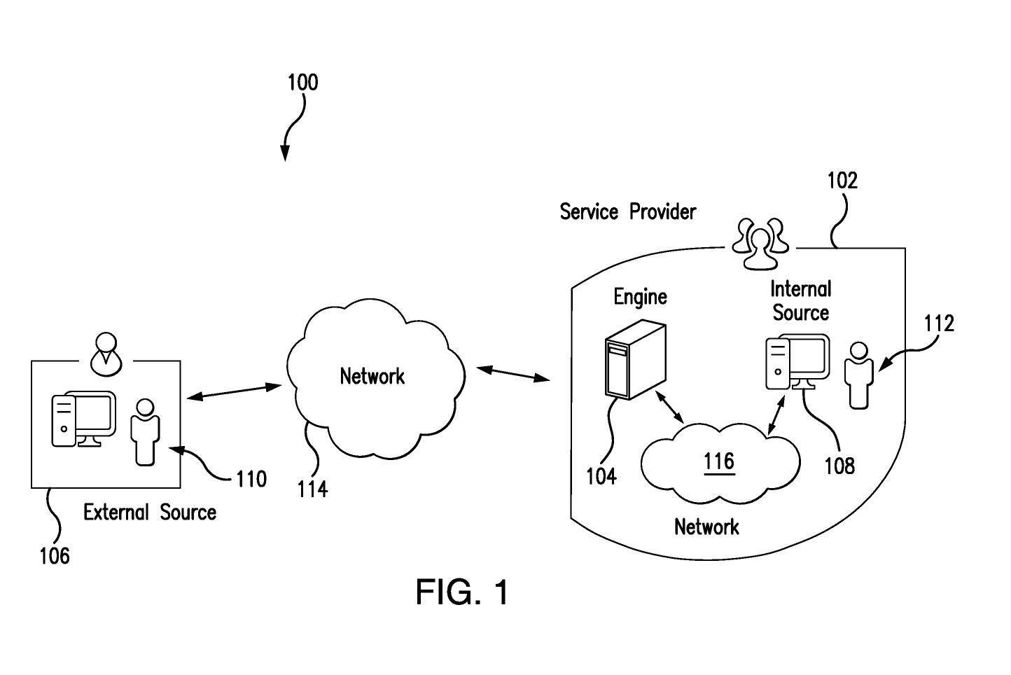

FIG. 1 illustrates an exemplary payment system 100, in which one or more aspects of the present disclosure may be implemented. Although components of the payment system 100 are presented in one arrangement, other embodiments may include the same or different components arranged otherwise, depending, for example, on services offered by service providers in the system 100, types of service providers in the system 100, arrangements of assets within the service providers, etc.

The illustrated payment system 100 generally includes a service provider 102, which is configured to offer services to customers through one or more assets (not shown). The assets may include, without limitation, infrastructure (e.g., computing devices, etc.), platform services (e.g., databases, etc.), and/or software, etc. In this exemplary embodiment, the service provider 102 includes a payment network, such as for example, the Mastercard® payment network. Among other services, the payment network interacts with customers, banking institutions, and others, to participate in the authorization, clearing and settlement of payment account transactions. The payment network may further provide other value-added services, such as, for example, virtual wallet services, digital identity services, merchant services, etc. That said, the service provider 102 may include any kind of entity offering any type of services to customers, whether the customers are individuals, entities, business, organizations, administrators, companies, etc.

The service provider 102 includes a risk engine 104, which is configured to operate as described herein. The service provider 102 is also subject to one or more changes (by way of one or more corresponding change requests), from time to time. When a change is identified (e.g., a change to infrastructure or to platform services, etc.), the change is associated with a change source. The change may include, for example, and without limitation, implementation of a new software, a new/replacement infrastructure, a software upgrade, a security patch, etc. In connection therewith, the system 100 includes an external change source 106 and an internal change source 108, each of which my implemented such a change. Each of the change sources 106 and 108 is associated with a user 110 and a user 112, respectively. The external change source 106 is coupled to and/or in communication with the service provider 102 (and specifically, the risk engine 104), via a network 114. The network 114 may include, without limitation, a wired and/or wireless network, a local area network (LAN), a wide area network (WAN) (e.g., the Internet, etc.), a mobile network, and/or another suitable public and/or private network capable of supporting communication among the illustrated parts of the system 100. Similarly, as shown, the internal change source 108 is coupled to and/or in communication with the risk engine 104 via a network 116, which is consistent with the network 114, but generally, is internal to the service provider 102.

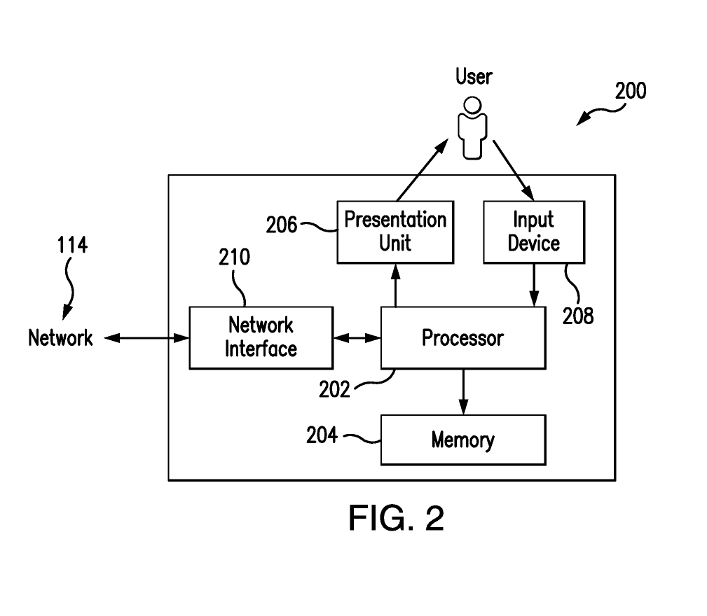

FIG. 2 illustrates an exemplary computing device 200 that can be used in the payment system 100. Further to the above, the computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, the risk engine 104, the internal change source 106, and the external change source 108 may be considered a computing device consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. In connection therewith, the computing device 200 is generally programmable to perform one or more operations described herein by programming the memory 204 and/or the processor 202.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, text descriptions, stop word lists, logistic regression models, historical records related to changes, predictive algorithms, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information to one or more of the users 110 and 112, in connection with one of more changes to the service provider 102, etc. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

In addition, the computing device 200 includes an input device 208 that receives inputs from the user (i.e., user inputs) such as, for example, entries of text descriptions of changes, by the users 110 and/or 112, etc. The input device 208 may include a single input device or multiple input devices. The input device 208 is coupled to (and is in communication with) the processor 202 and may include, for example, one or more of a keyboard, a pointing device, a mouse, a touch sensitive panel, another computing device, and/or an audio input device, etc. Further, in various exemplary embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the networks 114 and/or 116. In some exemplary embodiments, the computing device 200 includes the processor 202 and one or more network interfaces incorporated into or with the processor 202.

Referring again to FIG. 1, the risk engine 104 of the service provider 102 includes a data structure (not shown), which includes historical records related to prior changes (and associated change requests) implemented at the service provider 102, where each record includes a text description of the change and a text description of the problem/no problem result for the change when implemented. The record may further indicate one or more change factors, such as, for example, an owner of the change (and/or associated change request), an owner of an asset changed, a job plan ID, day of week of the change (e.g., Monday, Tuesday, Wednesday, etc.), a reporter of the change (e.g., a person, etc., whether the owner of the change or not), a domain of the change (e.g., a team assigned to the change and/or the underlying asset to be changed, etc.), a planned outage associated with the change, an outage type (e.g., a server outage or database outage, etc.), any data label and/or designations, and/or other suitable data, etc. The historical records generally form a training data set for the risk engine 104. As should be appreciated, as further historical records are compiled, when changes are implemented in the service provider 102, the training data set may be altered to add certain records (and/or delete other records), whereupon the operations herein may be repeated to refine and/or improve the predictive algorithm determined by the risk engine 104, as described below.

In this exemplary embodiment, the risk engine 104 is configured to generate a predictive risk model from the given training set. An exemplary predictive risk model is provided in Table 1, as generated through a random forest model/algorithm. In addition to including various variables (also referred to herein as change factors or features) for the predictive risk model, Table 1 also includes multiple coefficients (each associated a variable), which denote the contribution and/or weight of each variable in the predictive risk model, i.e., the relative importance of the variable, derived from the expected fraction of the samples to which those variables contributed. As shown, the exemplary predictive risk model includes thirteen variables, where two of the variables (variables 12 and 13) are based on text of a given change request (and change record) (and which go through a logistic regression process, as described further below).

TABLE 1

| | | Coefficient | | |
|---|---|---|---|---|
| | | of | | |
| | Variable | Importance | Definition | Value |
| 1 | changeby | 0.042394 | Employee ID who | Text coded to |
| | | | performs the changes. | number |
| 2 | mcw_risk | 0.011407 | Risk level of change | Categorical |
| | | | request associated with | value/term |
| | | | change, where key | coded to |
| | | | words are extracted as | number |
| | | | ‘none’, ‘low’, and | |
| | | | ‘others’ | |
| 3 | mcw_env | 0.094241 | Environment on which | Categorical |
| | | | change will be | value/term |
| | | | implemented, such as | coded to |
| | | | server, network etc. | number |
| 4 | action | 0.144768 | Type of action to be | Text coded to |
| | | | made by change | number (or |
| | | | request (e.g., break-fix, | categorical |
| | | | maintenance etc.) | value/term |
| | | | | coded to |
| | | | | number) |
| 5 | wopriority | 0.020759 | Priority of change | Range from |
| | | | associated with change | 1-5 |
| | | | request | |
| 6 | expected duration | 0.048551 | Time/duration for | Numeric |
| | | | change, as calculated | |
| | | | by target complete date | |
| | | | minus target start date | |
| | | | for change | |
| 7 | rush time | 0.201567 | Time/duration for | Numeric |
| | | | change, as calculated | |
| | | | by target start date | |
| | | | minus report date for | |
| | | | change | |
| 8 | backoutplan | 0.013059 | Indicator of whether | 1 or 0 |
| | | | change request | |
| | | | includes back out plan | |
| 9 | verification | 0.011837 | Indication of whether | 1 or 0 |
| | | | change request is | |
| | | | verified | |
| 10 | testplan | 0.007012 | Transformed from text | 1 or 0 |
| | | | to an indicator of | |
| | | | whether there has been | |
| | | | a test plan for change | |
| 11 | mcw_outage | 0.013826 | Indicator of whether | 1 or 0 |
| | | | there will be an outage | |
| | | | associated with change | |
| 12 | des_pred_score | 0.232830 | Text feature derived | Score from |
| | | | from description of | regression |
| | | | change in change | model in a |
| | | | request (processed as | range from 0 |
| | | | provided below) | to 1 |
| 13 | reason_pred_score | 0.157726 | Text feature derived | Score from |
| | | | from reason of the | regression |
| | | | change as included in | model in a |
| | | | change request | range from 0 |
| | | | (processed as provided | to 1 |
| | | | below) | |

It should be appreciated that a variety of different predictive risk models may be generated to predict one or more service outages in response to a change. In connection therewith, such models may be based on some or all of the variables above, and/or different variables. It should also be appreciated that the coefficients included in the predictive risk model in Table 1 are for illustration only, and that the coefficients, or other different coefficients for the same variables, or other coefficients for other variables, may be employed in the predictive risk model herein and/or in other, different models within the scope of the present disclosure.

In this exemplary embodiment, the predictive risk model generated by the risk engine 104 is generated through multiple operations. In addition, and as shown in Table 1, certain ones of the variables of the predictive risk model include discrete values, while other ones of the variables are derived from certain text included in the given change record. Specifically, for example, the “backoutplan” variable is defined as whether or not the change request includes a back out plan, and has discrete values of either 1 or 0 for answers of Yes or No. And, the text of the description of the change and the text of the reason for the change provide the description prediction score (i.e., the “des_pred_score” variable) and the reason prediction score (i.e., the “reason_pred_score” variable), respectively. As part of these later text-based variables, the risk engine 104 is configured to convert the text of the descriptions of the change and the text of the reason for the change into a particular value for the corresponding variable included in the predictive risk model (via a logistic regression as described next).

In particular, regarding the text-based variables, the risk engine 104 is configured to access the text of the description of each change (i.e., in each record) (and the text of the reason for the change or other text included in the record) in the training data set, and to normalize the text through one or more techniques (e.g., taking a natural language bag-of-words approach, etc.). For example, the risk engine 104 may be configured to initially clean the text, whereby the text is scrubbed of numbers, special characters, symbols, non-English language words, and/or words that are two characters or less in length, etc. Once cleaned, the risk engine 104 may be configured to remove one or more stop words from the cleaned text, when present. Example stop words include ‘and,’ ‘but,’ ‘is,’ ‘would,’ ‘about,’ ‘an,’ ‘she,’ ‘the,’ ‘then,’ and ‘like,’ etc., where the stop words are generally of minimal value, or no value, in determining whether a problem will occur or not in response to the change. And then, the risk engine 104, in normalizing the text, may be configured to stem the text, thereby reducing words to a root word and/or single version of the word (e.g. reducing the terms ‘run,’ ‘ran,’ ‘running,’ and other variations thereof (i.e., non-root words), to the same term (e.g., ‘run,’ etc.), reducing pythoner to python, while reducing pythonly to pythonli, etc.). As an example, text of a description of a change may include “Netezza Servers Monthly Maintenance - - - for Weekend Sat November 04th.” Based on the above, this text, then, may be normalized to “netezza server monthli mainten weekend sat novemb 04th.”

Once the text for the description of the change and/or the description of the reason of the change (for a given record) is normalized, the risk engine 104 is configured to perform a word count and/or frequency analysis on the normalized text. In this exemplary embodiment, the risk engine 104 is configured to generate a term frequency-inverse document frequency (tf-idf) matrix for the normalized text, whereby a numerical value is provided for each word in the normalized text that is intended to reflect the importance of the word to the document.

Specifically, to calculate the tf-idf, the risk engine 104 is configured to determine the tf of the normalized text as tf(t,d), which is the number of times the term t occurs in document d. That said, the tf may be determined in other manners, by the risk engine 104, in other system embodiment (e.g., via a Boolean frequency adjusted for document length, in a logarithmic manner, etc.). The risk engine 104 is further configured to calculate the idf of the normalized text as defined in Equation (1).

$$idf ( t , D ) = log \frac{n}{df ( d , t )} + 1 \qquad ( 1 )$$

In Equation (1), n is the total number of documents, and df(d,t) is the document frequency (i.e., the number of documents d that contain the term t). The “1” is added to the idf, so that terms with a zero idf, i.e., terms that occur in all documents in the training set, are not ignored entirely. In one variation that may be employed by the risk engine 104, a constant “1” may be added to the numerator and the denominator of the idf as if an extra document was seen containing every term in the collection exactly once, which prevents zero divisions. This modification/variation, then, provides an idf as defined by Equation (2).

$$idf ( t , D ) = log \frac{( 1 + N )}{( 1 + df ( d , t ) )} + 1 \qquad ( 2 )$$

Nonetheless, the risk engine 104 may be configured to employ one or more different word count and/or frequency analyses to the normalized text description in other embodiments.

With continued reference to FIG. 1, the risk engine 104 is configured to then perform a logistic regression on the tf-idf matrixes for the normalized text, as generated for each of the records in the training data set and the problem/no problem result for each of the records. In doing so, the risk engine 104 compiles a regression model having certain weights and/or coefficients for words, where the model is indicative of the probability of a problem based on the text of the description and/or the reason for the change (for the given record). In general, a separate regression model is generated for each of the description of the change and the reason for the change.

Then, when the regression models for the description of the change and the reason of the change are combined (as particular variables) with the change factors/variables and their coefficients in Table 1, the predictive risk model is provided. It should be appreciated that the risk engine 104 may be configured to update, re-compile, and/or regenerate the predictive risk model at one or more intervals, to account for records added and/or deleted from the training data set.

Subsequently in the system 100, when a change to the service provider 102 is to be implemented (e.g., a planned change, etc.), the external change source 106 or the internal change source 108 is configured to, as directed by the users 110 or 112, respectively, provide a text description of the change and a text description of a reason for the change to the risk engine 104 along with one or more changes factors (via a change request, etc.). As described above, such change factors may include, for example, an employee id of the person who conducts the change request; a risk level of the change request where key words are extracted as ‘none’, ‘low’, and ‘others’; an environment where the change request will be implemented; a type of action to be made to the change request; a priority of the change request; a time duration calculated by a target complete date minus a target start date; a time duration calculated by a target start date minus a report date; whether there is a back out plan; whether the change request is verified; whether there has been a test plan; an indicator of whether there will be an outage; and/or any data label and/or designations, and/or other suitable data, etc.

Upon receipt of the text of the description of the change, the text of the reason for the change, and the change factors for the change (broadly, the variables), the risk engine 104 is configured to normalize the text of the change, generate a tf-idf matrix for the normalized text, and apply the regression model to the tf-idf matrix to determine a text-based probability (generally, in the manner described above). This is done, by the risk engine 104, for both the text of the description of the change and the text of the reason for the change in the illustrated embodiment.

The risk engine 104 is configured to then determine a probability, based on the predictive risk mode previously generated from the training data set (e.g., from a random tree model, etc.) (e.g., as define din Table 1, etc.), which is the probability that the planned change will result in a problem in the service provider 102, when implemented. That probability, once generated, may then be used, by the user 110, the user 112 or some other user, or computing device, to permit one or more actions in connection with the change to be taken, or not, based on the probability (e.g., added oversight to the implementation of the planned change, etc.).

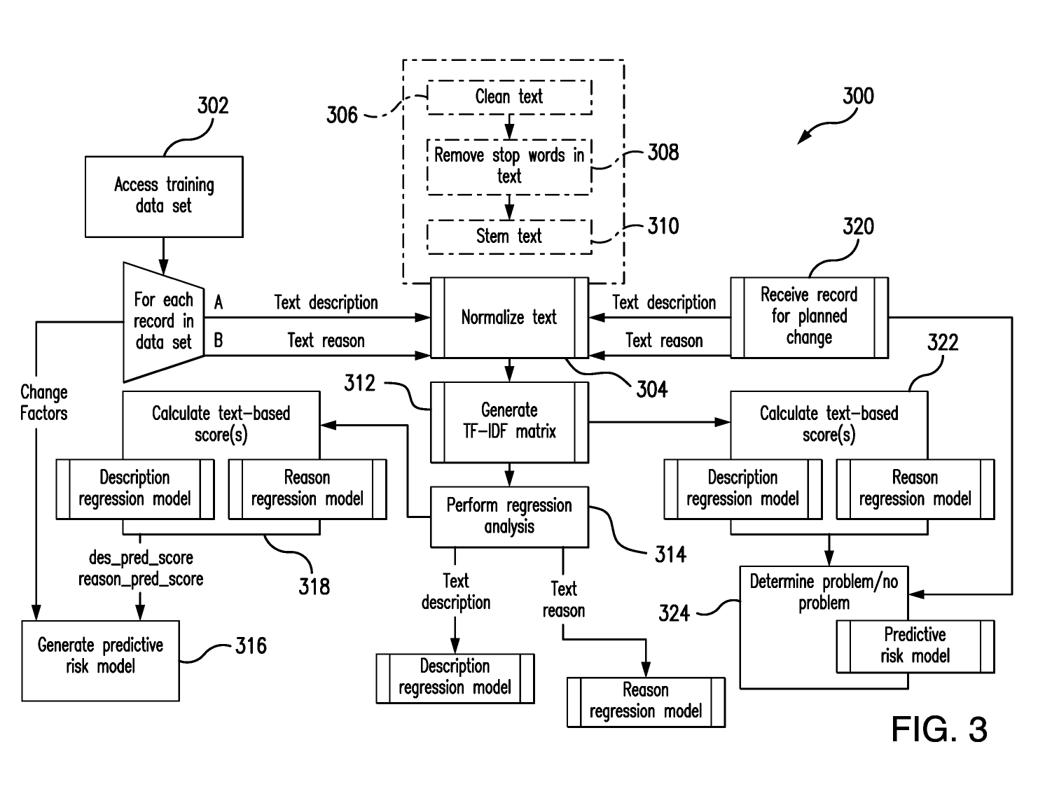

FIG. 3 illustrates an exemplary method 300 for providing a probability that a problem will occur at a service provider based on implementation of a change at the service provider. The exemplary method 300 is described as implemented in the system 100, and with reference to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

It should be appreciated that method 300 may be associated with an approval process for implementation of planned changes, whereby change requests are required for each potential planned change for the exemplary service provider 102. The problem/no problem indication and/or an underlying probability score herein may then be used by the approval process (e.g., by the risk engine 104, etc.) and/or committees associated with the approval process to approve (or not): implementation of the planned changes, management of implementation of the planned changes (e.g., implementation dates and/or times, available users for the implementation (e.g., necessary teams, etc.), etc.), etc.

Initially in the method 300, the risk engine 104 generates the predictive risk model. As described above in the system 100, the predictive risk model includes/indicates, for the given change to be implemented, whether there is expected to be a problem or no problem upon implementation of the change, based on prior implementations of prior changes. In connection therewith, the risk engine 104 builds the predictive risk model in stages. To start, the risk engine 104 accesses, at 302, the training data set in the data structure (of the service provider 102), which includes multiple historical records. Each of the historical records relates to a prior change, and includes at least a text description of the change, a text reason for the change, various change factors associated with the change (e.g., an employee associated with the change, a time to complete the change, a back out plan, a verification of the change, etc.), and a designation as to whether or not a problem resulted from the change.

Thereafter, in this embodiment, for each of the records included in the training data set, the risk engine 104 normalizes the text, at 304 (for both the text description (at path A) of the change and the text reason (at path B) for the change). Various techniques may be employed to normalize the text. Here, as indicated by the dotted box in FIG. 3, the risk engine 104 cleans the text, at 306, removes stop words, at 308, and stems the text, at 310. Specifically, cleaning the text (at 306) includes removing non-English language words (or, more generally, any words not in a “native” language of the document), if any, and also removing numbers, etc. The cleaning may further include removing symbols, spaces, and words less than a certain number of characters, or other suitable removals, etc. Removing stop words (at 308) includes removing particular words from the text as stored in a stop word list (in memory in the risk engine 104). The stop words list may include, for example: ‘and,’ ‘but,’ ‘is,’ ‘would,’ ‘about,’ ‘an,’ ‘she,’ and ‘like,’ etc., or other words which have minimal, or no impact on the probability of the change resulting, or not resulting in a problem, etc. And, stemming the text (at 310) includes replacing different forms of the same word in the given text with a root word. For example, the risk engine 104 may replace all forms of the word ‘run’ with the word ‘run,’ whereby ‘run,’ ‘ran,’ ‘running,’ etc. would be replaced with ‘run.’ In connection therewith, the risk engine 104 may stem all words in the text, or only a portion of the words, or potentially, only certain words, etc.

Once the text is normalized, for each record (and for both the text description of the change and the text reason for the change), the risk engine 104 generates a tf-idf matrix of the normalized text, at 312. Again, the risk engine 104 may employ one or more different count-type analyses of the normalized text, etc. As a result, the tf-idf matrix exists for each, or multiple, of the records included in the training data set. Then, at 314, the risk engine 104 performs a logistical regression on the tf-idf matrixes and the problem/no problem results associated with the records, thereby generating a regression model and providing for a numeric representation of the text generally without loss. The regression model, as an example, may include a term for each word in the text, whereby the model trains and/or tunes the coefficients of the terms to accurately quantify the probability of a problem or incident based on the given text. Through the regression model, the text is converted to a number, for example, in the range from 0 to 1, where the higher the number (in this embodiment), the more likely the text indicates a “problem” or incident.

As shown in FIG. 3, and as described above, the risk engine 104 performs operations 304-314 for both the text of the description of the change (at path A) and also for the text of the reason for the change (at path B), thereby providing a description regression model (for the text description) and a reason regression model (for the text reason). Both regression models are stored in memory of the risk engine 104 (or memory associated therewith) (e.g., the memory 204, etc.), and their additional use in the method 300 is indicated by the boxes labeled “Description regression model” and “Reason regression model”.

After generation of the regression models (for both of the text description and the text reason), the risk engine 104 returns to the accessed records from the training data set (at 302) and generates a predictive risk model, at 316. In so doing, the regression models for each of the text description and the reason description are used to calculate, at 318, respectively, a description prediction score (e.g., the des_prd_score variable in Table 1, etc.) and a reason prediction score (e.g., the reason_pred_score variable in Table 1, etc.) for use in generating the predictive risk model (along with various other change factors/variables included in the change record for the given change). In particular, based on those scores, and the various change factors included in the given change record of the training set (e.g., as listed in Table 1, etc.), along with the problem/no problem result associated with each record in the training data set, the predictive risk model is generated. In one specific example, the risk engine 104 employs the RandomForestClassifier from sklearn.ensemble package, with n_estimators=50, class_weight=‘balanced’, max_depth=6, and criterion=‘entropy’. See, e.g., http://scikit-learn.org/stable/modules/generated/sklearn.ensemble.RandomForestClassifier.html. As such, the n_estimators is the number of trees in the forest, where the number is selected to promote and/or ensure overfitting of the predictive risk model to the specific data, while also having sufficient estimators within the predictive risk model. It should be appreciated that the class_weight is selected to be balanced because the input is an unbalanced data set (i.e., the variables in Table 1). That is, the number of “no problem” indications (or non-incidents) generally outweighs (or even greatly outweighs) the number of “problem” indications (or incidents), and therefore, the predictive risk model is generated in a manner to put more weight and/or emphasis on the problem indications. In addition, the max_depth serves a similar function as the n_estimators, where the max_depth indicates the maximum tree depth. And, criterion is an evaluation method for the tree, which is chosen as entropy for information gain

In this exemplary embodiment, the risk engine 104 relies on an isolation forest algorithm to generate the predictive risk model (taking into account the above variables), yet the risk engine 104 may rely on other models and/or algorithms in other embodiments, to generate the predictive risk model. Like the regression model for each of the text description and the text reason, the predictive risk model is stored in the memory of the risk engine 104 and its further application in the method 300 is illustrated by the box in FIG. 3 labeled “Predictive risk model”.

With the predictive risk model generated, the risk engine 104 is prepared to assess the risk associated with further/new changes in service(s) at the service provider 102. As such, when a next change is planned, a descriptive record is generated for the change, which includes a text description of the change, a text reason for the changes, and other values for each of the change variables listed in Table 1 (for example). The text, information and/or values are included in a change record/change request for the change.

In connection therewith, the risk engine 104 receives, at 320, a record for a planned change at the service provider 102, which includes a text description of the planned change, a text reason for the change, and one or more change factors for the planned change. Similar to the above, for each of the text description and the text reasons, the risk engine 104 normalizes the text, at 304 (e.g., by cleaning, removing stop words, and/or stemming the text, etc.), consistent with the description above. The risk engine 104 then proceeds to generate, at 312, a tf-idf matrix and/or perform a different count-based analysis of the text. The tf-idf matrix is provided to the regression model for the text description and the text reason, whereby the risk engine 104 calculates, at 322, the description prediction score (i.e., des_prd_score) and the reason prediction score (i.e., reason_pred_score) based on the tf-idf matrixes for the text description and the text reason. Next, the risk engine 104 calculates, at 324, the “problem” or “no problem” indication for the anticipated change at the service provider 102, through use of the predictive risk model and the associated factors relating to the text-based probability scores and the change factors included in the change record for the planned change. Specifically, the “problem” or “no problem” indication is a score calculated by the risk engine 104, which ranges from 0 to 1, for example, where 0 indicates no risk/problem and 1 indicates a likely and/or definite problem. A threshold is imposed on the range from 0 to 1, for example, where scores above (and/or equal to) the threshold are provided the “problem” indication while scores below (and/or equal to) the threshold are provided with the “no problem” indication. The threshold may be set to 0.5 in this example, but may be set otherwise in other examples. Overall, in this embodiment, the risk engine 104 outputs the indication of “problem” or “no problem” and also a specific risk score in the range of 0 to 1 (or whatever range is provided for the given embodiment). The indication (and/or the probability/risk score associated with the indication) may then be reported by the risk engine 104 or other entity (e.g., the external change source 106, the internal change source 108, etc.), whereby one or more users and/or computing devices may review, alter, and/or highlight the implementation of the change (e.g., when the probability exceeds a predefined threshold, etc.).

In addition, in response to a probability/risk score indicative of a problem (e.g., a score greater than 0.5, etc.) (as generated at 324), the engine 104 may further alter a timing associated with implementation of the planned change (e.g., the risk engine 104 may specify implementation of the planned change during off-peak hours or off-peak months, etc.) and/or deploy/assign a specific team of users and/or additional users associated with the change to be implemented to be present at the service provider 102 at the time of implementation of the planned change. In connection therewith, the team of users and additional users may be specifically skilled and/or trained in dealing with problems associated with the service provider 102 and/or the specific service or associated services involved in the planned change. In at least one embodiment, the problem/no problem indication or the underlying score (e.g., from the predictive risk model, etc.) (determined at 324) may be provided to another automated process, which may determine and/or approve/decline details and/or management of the implementation of the planned change as appropriate (e.g., based on the probability/risk score, etc.), etc.

Further, after one or more intervals, the risk engine 104 may return to 302, and again proceed through method 300, to generate a new and/or updated predictive algorithm. In this manner, risk engine 104 is able to account for implementation of further changes and results indicating whether or not the changes resulted in a problem, thereby improving the accuracy of the predictive algorithm over time and/or based one recent implementation problems.

In view of the above, the systems and method herein provide a predictive risk model for use in implementing changes to services at servicer providers, whereby a prediction as to whether or not problems will arise from implementation of the planned changes is provided. In this manner, service providers may more precisely implement planned changes, while having sufficient coverage to promptly remedy problems associated with the planned changes for the given services (rather than reacting after the problems arise). This will result is shorter down times and/or readily available remedies associated with the problems caused by implementation of the changes (as such problems may be anticipated in advance of actually implementing the changes).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing, by a risk engine computing device, a training data set for changes associated with a provider, the training data set including multiple records, each record including a text description of an implemented change included in the record, one or more change factors associated with the change and a problem/no problem result for the change; (b) for each record in the training data set: (i) normalizing, by the risk engine computing device, the text description of the implemented change included in the record; (ii) generating, by the risk engine computing device, a word-count matrix based on the normalized text description; (iii) normalizing, by the risk engine computing device, a text description of a reason for the implemented change included in the record; and (iv) generating, by the risk engine computing device, a word-count matrix based on the normalized text description of the reason; (c) for the training data set, performing, by the risk engine computing device, a regression analysis of the generated word-count matrices for the multiple records and the problem/no problem results included in the records (for both the text descriptions of the implemented changes and the text descriptions of the reasons for the implemented changes), thereby providing a regression model based on the text descriptions of the implemented changes included in the multiple records of the training data set and a reason regression model based on the text descriptions of the reasons for the implemented changes; (d) generating and storing, by the risk engine computing device, a predictive risk model, using a classifier algorithm, based on a score provided from the regression model, a score provided from the reason regression model, and at least one of the one or more change factors included in at least one of the multiple records of the training data set, whereby the risk engine computing device is permitted to predict, via the predictive risk model, a probability of a problem in a service provided by a provider in response to implementation of a planned change to the service, based on a text description of the planned change and the at least one of the one or more change factors for the planned change; (e) receiving a change request for the planned change; and (f) predicting, by the risk engine computing device, via the predictive risk model, the probability of the problem in the service provided by the provider in response to implementation of the planned change, based on the text description of the planned change and the at least one of the one or more change factors for the planned change.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a text description of a planned change for a service associated with the provider, a text description of a reason for the planned change, and multiple values for change factors for the planned change; and (b) calculating, by a risk engine computing device, a probability of the planned change causing a problem at the provider, when implemented, based on a predictive risk model derived from a training data set of prior changes to services implemented at the provider.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a probability of a problem at a provider based on implementation of a change at the provider, the method comprising:
accessing, by a risk engine computing device, a training data set for changes associated with a provider, the training data set including multiple records, each record including a text description of an implemented change included in the record, one or more change factors associated with the change and a problem/no problem result for the change;
for each record in the training data set:
normalizing, by the risk engine computing device, the text description of the implemented change included in the record; and
generating, by the risk engine computing device, a word-count matrix based on the normalized text description;
for the training data set, performing, by the risk engine computing device, a regression analysis of the generated word-count matrices for the multiple records and the problem/no problem results included in the records, thereby providing a regression model based on the text descriptions of the implemented changes included in the multiple records of the training data set; and
generating and storing, by the risk engine computing device, a predictive risk model, using a classifier algorithm, based on a score provided from the regression model and at least one of the one or more change factors included in at least one of the multiple records of the training data set, whereby the risk engine computing device is permitted to predict, via the predictive risk model, a probability of a problem in a service provided by a provider in response to implementation of a planned change to the service, based on a text description of the planned change and the at least one of the one or more change factors for the planned change.

2. The computer-implemented method of claim 1, wherein normalizing the text description of the implemented change includes cleaning, by the risk engine computing device, numbers, non-English language words, special characters, and/or symbols from the text description.

3. The computer-implemented method of claim 2, wherein normalizing the text description further includes removing stop words, included in a stop word list, in a memory of the risk engine computing device, from the text description.

4. The computer-implemented method of claim 3, wherein normalizing the text description further includes stemming words included in the text description, when the words in the text description include non-root words.

5. The computer-implement method of claim 1, wherein generating the word-count matrix includes generating a term frequency-inverse document frequency (tf-idf) matrix of the normalized text description.

6. The computer-implement method of claim 5, wherein performing the regression analysis of the word-count matrices includes performing a logistic regression analysis of the tf-idf matrices generated by the risk engine computing device for the multiple records and the problem/no problem results of the multiple records of the training data set.

7. The computer-implement method of claim 1, wherein each of the multiple records in the training set further includes a text description of a reason for the implemented change included in the record;
wherein the method further comprises, for each record in the training data set:
normalizing, by the risk engine computing device, the text description of the reason for the implemented change included in the record; and
generating, by the risk engine computing device, a word-count matrix based on the normalized text description of the reason;
wherein performing the regression analysis includes performing the regression analysis of the generated word-count matrices based on the text descriptions of the implemented changes, the generated word-count matrices for the multiple records based on the text descriptions of the reasons for the implemented changes, and the problem/no problem results included in the records, thereby providing a reason regression model based on the text descriptions of the reasons for the implemented changes included in the multiple records of the training data set; and
wherein generating the predictive risk model includes generating the predictive risk model further based on the reason regression model.

8. The computer-implemented method of claim 1, further comprising:
receiving a change request for the planned change; and
predicting, by the risk engine computing device, via the predictive risk model, the probability of the problem in the service provided by the provider in response to implementation of the planned change, based on the text description of the planned change and the at least one of the one or more change factors for the planned change.

9. The computer-implement method of claim 8, wherein the at least one of the one or more change factors includes multiple of: an employee identifier of a user that submitted a change request for the planned change, a risk level of the planned change included in the change request, a type of the planned change, a priority of the planned change, a time duration of the planned change, whether a back out plan exists for the planned change, whether the change request is verified, and whether a test plan exists for the planned change.

10. A computer-implemented method of providing a probability of a problem at a provider based on implementation of a change at the provider, the method comprising:
receiving a text description of a planned change for a service associated with the provider, a text description of a reason for the planned change, and multiple values for change factors for the planned change; and
calculating, by a risk engine computing device, a probability of the planned change causing a problem at the provider, when implemented, based on a predictive risk model derived from a training data set of prior changes to services implemented at the provider.

11. The computer-implement method of claim 10, wherein the change factors include multiple of: an employee identifier of a user that submitted a change request for the planned change, a risk level of the planned change included in the change request, a type of the planned change, a priority of the planned change, a time duration of the planned change, whether a back out plan exists for the planned change, whether the change request is verified, and whether a test plan exists for the planned change.

12. The computer-implemented method of claim 11, wherein the predictive risk model includes weights for each of the change factors.

13. The computer-implemented method of claim 11, further comprising:
normalizing, by the risk engine computing device, the text description of the reason for the planned change;
generating, by the risk engine computing device, a term frequency-inverse document frequency (tf-idf) matrix based on the normalized text description of the reason for the planned change; and
determining a probability score for the text description of the reason for the planned change, based on a regression analysis of the tf-idf matrix;
wherein calculating the probability of the planned change causing a problem at the provider is further based, at least in part, on the determined probability score for the text description of the reason for the planned change.

14. The computer-implemented method of claim 13, further comprising:
normalizing, by the risk engine computing device, the text description of the planned change;
generating, by the risk engine computing device, a tf-idf matrix based on the normalized text description of the planned change; and
determining a probability score for the text description of the planned changed, based on a regression analysis of the tf-idf matrix; and
wherein calculating the probability of the planned change causing a problem at the provider is further based, at least in part, on the determined probability score for the text description of the planned change.

15. The computer-implemented method of claim 13, further comprising altering a timing associated with implementation of the planned change based on the probability of the planned change causing a problem at the provider.

16. A non-transitory computer readable storage media including executable instructions for use in providing a probability of a problem at a provider based on implementation of a change at the provider, which when executed by at least one processor, cause the at least one processor to:
access a training data set for changes associated with a provider, the training data set including multiple records, each record including a text description of an implemented change and/or text description of a reason for the implemented change included in the record and a problem/no problem result for the change; and
for each record in the training data set:
normalize the text description(s) included in the record; and
generate a word-count matrix based on the normalized text description(s);
for the training data set, perform a regression analysis of the generated word-count matrices for the multiple records and the problem/no problem results included in the records, thereby providing a regression model based on the text descriptions of the implemented changes and/or the text descriptions of the reasons for the implemented changes included in the multiple records of the training data set; and
generate and store in a memory a predictive risk model, using a classifier algorithm, based on one or more scores provided from the regression model and at least one change factor associated with at least one of the multiple records of the training data set, whereby the risk engine is permitted to predict, via the predictive risk model, a probability of a problem in a service provided by a provider in response to implementation of a planned change to the service, based on a text description of the planned change and the at least one change factor for the planned change.

17. The non-transitory computer readable storage media of claim 16, wherein the executable instructions, when executed by the at least one processor, cause the at least one processor, in order to perform the regression analysis, to:
perform a first regression analysis of the generated word-count matrices for the multiple records based on the text descriptions of the implemented changes and the problem/no problem results included in the records; and
perform a second regression analysis of the generated word-count matrices for the multiple records based on the text descriptions of the reasons for the implemented changes and the problem/no problem results included in the records; and
wherein the executable instructions, when executed by the at least one processor, cause the at least one processor to generate the predictive risk model based on scores from the first and second regression analyses.

18. The non-transitory computer readable storage media of claim 16, wherein the executable instructions, when executed by the at least one processor, cause the at least one processor, in order to generate the word-count matrix for each record in the training data set, to generate a term frequency-inverse document frequency (tf-idf) matrix of the normalized text description(s); and
wherein the executable instructions, when executed by the at least one processor, cause the at least one processor, in order to perform the regression analysis, to perform the regression analysis of the generated tf-idf matrices and the problem/no problem results of the multiple records of the training data set.

19. The non-transitory computer readable storage media of claim 16, wherein the predictive risk model includes weights for each of the one or more scores and the at least one change factor.
